(19) United States
(12) Patent Application Publication
(10) Pub. No.: US 2017/0154647 A1
(43) Pub. Date: Jun. 1, 2017

(54) STACKED INTERMEDIATE LAYER FOR PERPENDICULAR MAGNETIC RECORDING MEDIA

(71) Applicant: WD Media, LLC, San Jose, CA (US)

(72) Inventors: DAEHOON HONG, FREMONT, CA (US); SY VU, SAN JOSE, CA (US); KYONGHA KANG, FREMONT, CA (US); MRUGESH DESAI, SAN JOSE, CA (US)

(21) Appl. No.: 14/954,111

(22) Filed: Nov. 30, 2015

(51) Int. Cl. G11B 5/73; G11B 5/667; G11B 5/851

(52) U.S. Cl. CPC G11B 5/73; G11B 5/851; G11B 5/667; G11B 5/732; G11B 5/7325

(57) ABSTRACT

One aspect of a perpendicular magnetic recording (PMR) media stack includes two intermediate layers, and a spacer layer formed between the two intermediate layers, wherein a surface energy of the spacer layer is lower than a surface energy of the two intermediate layers.

### BACKGROUND

Hard disk drives read from and write to magnetic patterns on magnetic storage media, which can be used to store data. Hard disk drives offer low cost, high recording capacity, and relatively rapid data retrieval. While the basic principle of reading and writing magnetic patterns on rotating disks (e.g., media disks) remains the same, components of the disk drive, particularly the magnetic storage media have significantly evolved requiring thinner layers formed on the media disks. A magnetic storage medium may be implemented by a PMR media stack that includes various layers.

### BRIEF DESCRIPTION OF THE DRAWINGS

FIG. 1 is a diagram illustrating a PMR media stack according to an exemplary embodiment.

FIGS. 2a-2c are diagrams illustrating a growth mechanisms of a PMR media stack according to an exemplary embodiment.

FIG. 3 is a flow chart illustrating an exemplary embodiment for forming a PMR media stack according to an exemplary embodiment.

FIG. 4 is a conceptual view of an exemplary PMR hard drive disk.

### DETAILED DESCRIPTION

In one example, perpendicular magnetic recording (PMR) has been used to increase the areal recording density of magnetic storage media. A PMR media stack generally includes a substrate, an antiferromagnetic coupled soft magnetic underlayer (AFC-SUL), a seed layer, an intermediate layer (IL), a grain isolation initiation layer (GIIL), and a magnetic layer stack. The magnetic layer stack includes a number of magnetic layers separated by a number of exchange-break layers (EBLs). The main role of seed layer is to control grain size and develop preferred orientation for ILs and magnetic layers. The IL is used to improve orientation further and to provide a proper template for the magnetic layer so that grain isolation of magnetic layers is enhanced and intergranular magnetic coupling is substantially reduced. Ruthenium (Ru) has been widely used for the IL in PMR media since no alternative shows better properties than Ru.

However, since areal density of magnetic storage media continues to increase, grain size and intergranular magnetic coupling need to be reduced further. The current IL used in PMR media stacks is unable to meet this requirement. Thus, there is a need to provide a PMR media stack that is able to reduce the core grain size of the magnetic layers and widen grain boundaries to result in a signal-to-noise (SNR) gain mainly due to reduction of grain size and intergranular magnetic coupling.

In the following detailed description, various aspects of a PMR media stack and method of manufacture will be presented. These aspects are well suited for reducing the core grain size of the magnetic layers and widening grain boundaries to result in a SNR gain due to reduction of grain size and intergranular magnetic coupling. Those skilled in the art will realize that these aspects may be extended to all types of media disks such as optical disks, floppy disks, or any other suitable disk capable of storing data through various electronic, magnetic, optical, or mechanic changes to the surface of the disk. Accordingly, any reference to a specific system, apparatus, or method is intended only to illustrate the various aspects of the present invention, with the understanding that such aspects may have a wide range of applications.

One aspect of a PMR media stack includes two intermediate layers, and a spacer layer formed between the two intermediate layers, wherein a surface energy of the spacer layer is lower than a surface energy of the two intermediate layers.

One aspect of a method of forming a PMR media stack includes forming two intermediate layers, and forming a spacer layer between the two intermediate layers, wherein a surface energy of the spacer layer is lower than a surface energy of the two intermediate layers.

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention.

The word “exemplary” is used herein to mean serving as an example, instance, or illustration. Any embodiment described herein as “exemplary” is not necessarily to be construed as preferred or advantageous over other embodiments. Likewise, the term “embodiment” of a system, apparatus, or method does not require that all embodiments of the invention include the described components, structure, features, functionality, processes, advantages, benefits, or modes of operation.

It will be understood that other aspects of the present invention will become readily apparent to those skilled in the art from the following detailed description, wherein it is shown and described only several embodiments of the invention by way of illustration. As will be realized by those skilled in the art, the present invention is capable of other and different embodiments and its several details are capable of modification in various other respects, all without departing from the spirit and scope of the invention. For example, while embodiments related to PMR are discussed below, other embodiments (e.g., for shingled magnetic recording or other types of recording technologies) are possible.

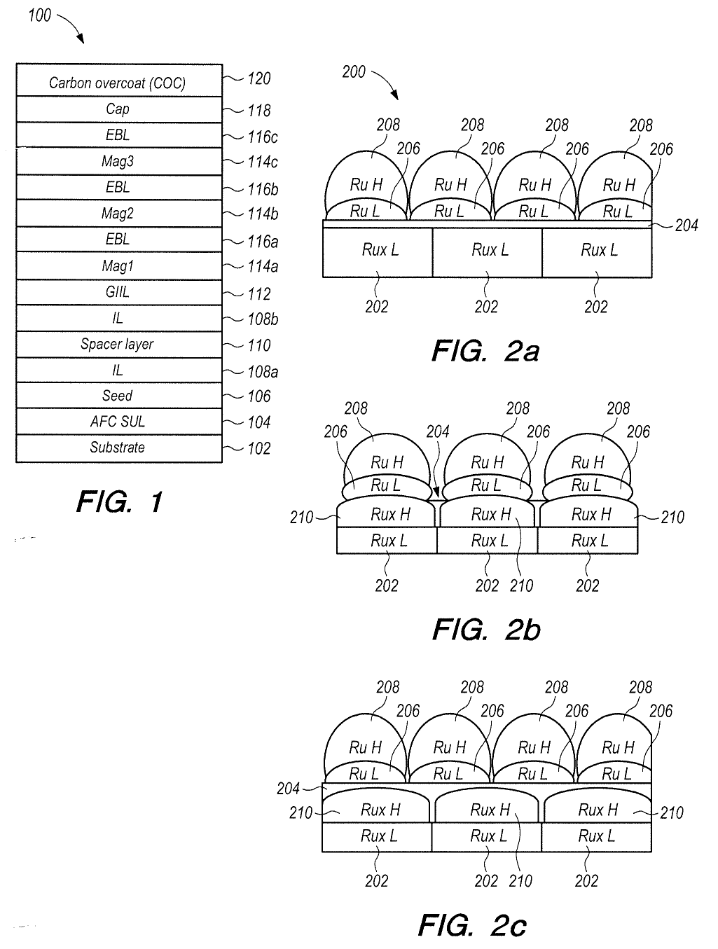

FIG. 1 illustrates a PMR media stack 100 providing an improved grain boundaries and SNR in accordance with an aspect of the present disclosure. Reduction of grain size and inter-granular magnetic coupling of magnetic layers in a PMR media stack is a key challenge for improving the SNR for PMR media. According to one aspect the present disclosure, a PMR media stack of an exchange coupled composite media (ECC) with improved SNR and a method of manufacturing the same are provided.

According to one aspect, the PMR media stack 100 may include a substrate 102, one or more soft magnetic underlayers (SUL) such as an antifermagnetically-coupled SUL (AFC SUL) 104, a seed layer 106, two or more intermediate underlayers (ILs) 108a, 108b, a spacer layer 110, a number of magnetic layers (e.g., Mag1, Mag2, Mag3) 114a-114c each separated from one another by an exchange-break layer (EBL) 116a-116c, a cap 118, and a carbon overcoat (COC) layer 120.

The seed layer 106 and the two or more ILs 108a, 108b may be used to improve crystallographic orientation and to control grain size and distribution of magnetic recording layers 114a-114c. By way of example, Ru or an Ru alloy (Rux) may be selected for use as the ILs 108a, 108b since Ru may help grain orientation of magnetic layers 114a-114c. In addition, Ru may also suppress magnetic coupling of the magnetic recording layers 114a-114b by providing a growth template with a rougher surface. Alternatively, cobalt (Co), a Co alloy (Cox), platinum (Pt), or a Pt alloy (Ptx) may be selected for one or more of the ILs 108a, 108b. In an aspect, formation of each of the ILs 108a, 108b may include a two step process, where the first Rux layer is sputtered at low pressure (Rux L) and the second Rux layer is sputtered at high pressure (Rux H). The Rux L (not illustrated in FIG. 1) may improve orientation of the magnetic layers 114a-114c, while the Rux H (also not illustrated in FIG. 1) may improve grain separation of the magnetic layers 114a-114c.

The insertion of a spacer layer 110 in between IL 108a and IL 108b may reduce the size of the grains in the ILs 108a, 108b and magnetic recording layers 114a-114c when the surface energy of the spacer layer 110 is selected to lower than the surface energies of the ILs 108a, 108b. For example, the ILs 108a, 108b may be formed from Ru or Rux, and the spacer layer 110 be copper (Cu). Since the surface energy of Cu is relatively low compared to Ru and/or Rux, and the lattice parameter of Cu is similar to Ru, using Cu as the spacer layer 110 may result in epitaxial growth of IL 108b without orientation degradation. Thus, the PMR media stack 100 may include an Ru—Cu—Ru stacked IL configuration, which may allow the grains of magnetic layers 114a-114c to include a small grain size, narrow size distribution, and be well decoupled magnetically for SNR improvement.

In addition, the AFC SUL 104 may be used to reduce noise when reading and writing data to/from the PMR media stack 100. The GIIL 112 and EBLs 116a-116c may control and improve segregation of magnetic grains in each of the magnetic layers 114a-114b, while the cap 118 and COC 120 may be used to may used to protect the PMR media stack 100 against corrosion.

FIGS. 2a-2c illustrate an exemplary embodiment of a growth mechanism of Ru or Rux ILs with a Cu spacer layer (Cu SL). For example, each of the ILs 108a, 108b illustrated in FIG. 1 can include two Ru layers. The first Ru layer is sputtered at low pressure to develop good grain orientation, and subsequently the second Ru layer is sputtered at high pressure to provide a dome shaped surface for magnetic layer growth. This dome shaped template may aid the magnetic layers to grow with good magnetic separation between grains.

As illustrated in FIG. 2a, a Cu spacer layer (Cu SL) 204 is positioned between Rux L 202 and Rux L 206. The surface roughness of Rux L 202 is quite low and the surface energy of Ru is much higher compared to the surface roughness and surface energy of Cu SL 204. Therefore, the Cu SL 204 grows layer-by-layer covering the whole surface of Rux L 202 to minimize surface energy, while Rux L 206 sputtered on Cu SL 206 forms small islands instead of layer-by-layer growth. This is because the surface energy of Rux L 206 is higher than that of Cu SL 204. In the example illustrated in FIG. 2a, the center-to-center distance of grains of Rux L 206 also decreases together with grain size as compared to Rux L 202. The decreased size of Rux L 206 grains may be desirable for SNR by helping magnetic layers (e.g., layers 114a-114c in FIG. 1) to grow with good magnetic separation between grains. This is further aided by having Rux H 208 formed with a further dome shape on Rux L 206.

Referring now to FIG. 2b, this exemplary embodiment illustrates an Rux L 202 and Rux H 210 that are sputtered before Cu SL 204. With the help of dome shaped Rux H 210, a Cu SL 204 fills the valley of Rux H 210 grains without covering top of the Rux H 210 grains. The subsequent Rux L 206 IL grows only at the top of the Rux H 210 and widens thickness of grain boundaries of the IL (e.g., which includes Rux L 206 and Rux H 208). This is because Ru does not like to grow on top of the Cu SL 204 filled at grain boundaries of Rux H 210 due to surface energy difference. As a result, grain size and thickness of grain boundary can be controlled by the thickness of a Cu SL 204.

Referring now to FIG. 2c, this exemplary embodiment illustrates that beyond a certain thickness the Cu SL 204 covers whole surface of Rux H 210 including peak and valley of grains and flatten out surface of the IL that includes Rux L 202 and Rux H 210. This may provide new surface for the growth of the subsequent Ru IL that includes Rux L 206 and Rux H 208.

In this way, the Cu SL 204 may be used to refine grain size and widen grain boundary thickness of the ILs 108a, 108b and magnetic layers 114a-114c illustrated in FIG. 1. The Rux-Cu-Rux stacked IL illustrated in FIGS. 2a-2c may reduce core grain size of magnetic layers 114a-114b illustrated in FIG. 1 and widen grain boundary. This may result in SNR gain for the PMR media stack due to reduction of grain size and intergranular magnetic coupling.

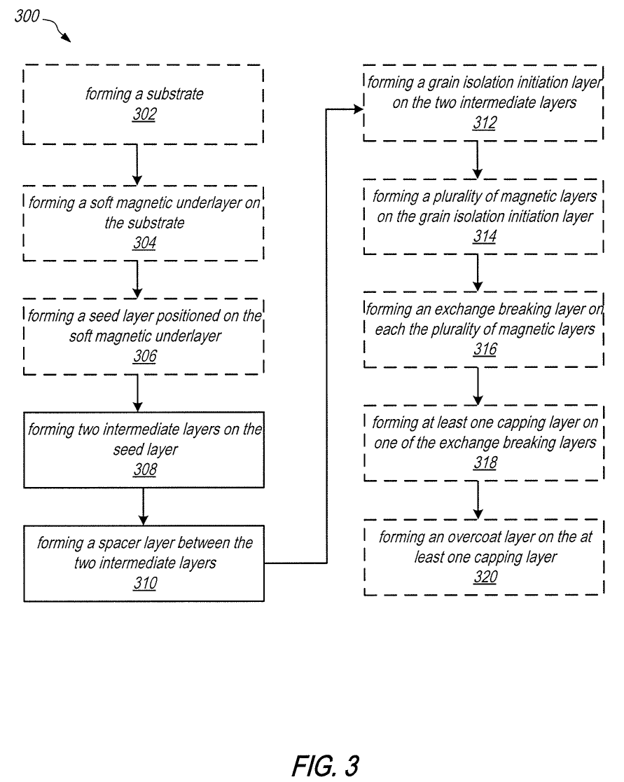

FIG. 3 is a flow chart 300 illustrating an exemplary embodiment of a according to one aspect of the present disclosure. For example, the PMR media stack 100 illustrated in FIG. 1 can be manufactured using the method illustrated in FIG. 3. Each of the steps in the flow chart can be controlled using one or more processors of a deposition apparatus or by some other suitable means. It should be understood that the operations indicated with dashed lines represent optional operations for various aspects of the disclosure.

As represented by block 302, a substrate can be formed. For example, referring to FIG. 1, the substrate 102 can be formed for a PMR media stack 100.

As represented by block 304, a soft magnetic underlayer can be formed on the substrate. For example, referring to FIG. 1, an AFC SUL 104 can be formed on the substrate 102. In an aspect, the AFC SUL 104 may be used to reduce noise when reading and writing data to/from the PMR media stack 100.

As represented by block 306, a seed layer can be formed on the soft magnetic underlayer layer. For example, referring to FIG. 1, a seed layer 106 can be formed on AFC SUL 104. The seed layer 106 may be used to control grain size and develop preferred orientation for ILs and magnetic layers.

As represented by block 308, two intermediate layers can be formed on the seed layer, and as represented by block 310, a spacer layer can be formed between the two intermediate layers. In one aspect, each of the two intermediate layers include at least one of Ru, Co, or Pt, and the spacer layer includes at least one of Cu, Al, Ag, or Au. In an aspect, the forming the two intermediate layers includes forming a first of the two intermediate layers by sputtering a first layer at a first pressure and forming a second of the two intermediate layers by sputtering a second layer at a second pressure onto the first layer, the first pressure being lower than the second pressure. For example, the first pressure includes a range of 2-10 mTorr, and the second pressure includes a range of 40-150 mTorr. In another aspect, the first of the two intermediate layers includes a plurality of grains, each of the plurality of grains being formed with a domed portion such that a valley is formed at a grain boundary between each of the plurality of grains. In a further aspect, the forming the spacer layer comprises forming the spacer layer in the valley located at the grain boundary between each of the plurality of grains. In still a further aspect, the spacer layer is not formed on the domed portion of the plurality of grains. In another aspect, the forming the two intermediate layers further includes forming a second of the two intermediate layers on the domed portion of each of the plurality of grains of the first of the two intermediate layers. For example, referring to FIG. 2b, an Rux L 202 and Rux H 210 that are sputtered before Cu SL 204. With the help of dome shaped Rux H 210, a Cu SL 204 fills the valley of Rux H 210 grains without covering top of the Rux H 210 grains. The subsequent Rux L 20 IL grows only at the top of the Rux H 210 and widens thickness of grain boundaries of the IL (e.g., which includes Rux L 206 and Rux H 208). This is because Ru does not like to grow on top of the Cu SL 204 filled at grain boundaries of Rux H 210 due to surface energy difference. As a result, grain size and thickness of grain boundary can be controlled by the thickness of a Cu SL 204.

As represented by block 312, a grain isolation initiation layer can be formed on the two intermediate layers. For example, referring to FIG. 1, the GIIL 112 be formed on the ILs 108a, 108b, and may control and improve segregation of magnetic grains in each of the magnetic layers 114a-114b.

As represented by block 314, a plurality of magnetic layers can be formed on the grain isolation initiation layer. For example, referring to FIG. 1, the grain size and distribution of magnetic recording layers 114a-114c may be controlled by the seed layer 106 and the two or more ILs 108a, 108b.

As represented by block 316, an exchange breaking layer can be formed on each the plurality of magnetic layers. For example, referring to FIG. 1, a number of magnetic layers (e.g., Mag1, Mag2, Mag3) 114a-114c can each be separated from one another by EBL 116a-116c. The EBLs 116a-116c may reduce a coercivity and saturation field of the PMR media stack 100, which results in improvement of writability and SNR of media.

A represented by block 318, at least one capping layer can be formed on one of the exchange breaking layers, and as represented by block 320, at least one overcoat layer can be formed on the at least one capping layer. For example, referring to FIG. 1, the cap 118 and COC 120 may be used to may used to protect the PMR media stack 100 against corrosion.

In this way, a PMR media stack may be formed that includes an Ru—Cu—Ru stacked IL configuration, which may allow the grains of magnetic layers to include a small grain size, narrow size distribution, and be well decoupled magnetically for SNR improvement.

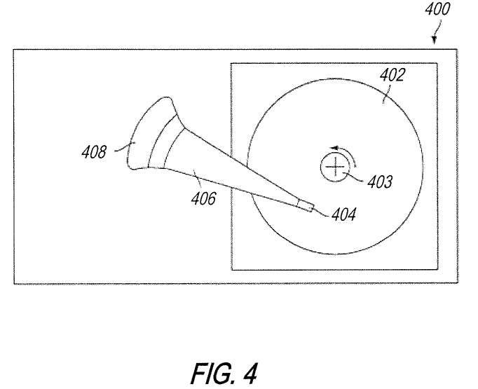

FIG. 4 is a conceptual view of an exemplary PMR hard drive disk. The PMR hard drive disk 400 is shown with a rotatable PMR media stack 402. The PMR media stack 402 may be rotated on a spindle 403 by a disk drive motor (not shown) located under the PMR media stack 402. A PMR head 104 may be used to write to and read from the PMR media stack 402. As the motor rotates the magnetic disk 402, an air bearing may be formed under the PMR head 404 causing it to lift slightly off the surface of the PMR media stack 402, or as it is termed in the art, to “fly” above the magnetic disk 402. The PMR head 404 may be used to read and write information by detecting and modifying the magnetic polarization of the material on the disk's surface. An actuator or access arm 406 may be used to move the PMR head 404 on an arc across the rotating PMR media stack 402, thereby allowing the PMR head 404 to access the entire surface of the PMR media stack 402. The arm 406 may be moved using a voice coil actuator 408 or by some other suitable means.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A perpendicular magnetic recording (PMR) media stack, comprising:
two intermediate layers; and
a spacer layer formed between the two intermediate layers, wherein a surface energy of the spacer layer is lower than a surface energy of the two intermediate layers.

2. The PMR media stack of claim 1, wherein:
a first of the two intermediate layers includes a top layer including a plurality of top grains and a lower layer including a plurality of lower grains;
each of the plurality of top grains comprises a domed portion such that a valley is located at a grain boundary between each of the plurality of top grains; and
the plurality of lower grains do not include a domed portion.

3. The PMR media stack of claim 2, wherein the plurality of top grains have a larger grain boundary than the plurality of lower grains.

4. The PMR media stack of claim 2, wherein the spacer layer is in the valley located at the grain boundary between each of the plurality of top grains.

5. The PMR media stack of claim 4, wherein the spacer layer is not on the domed portion of the plurality of top grains.

6. The PMR media stack of claim 4, wherein a second of the two intermediate layers is on the domed portion of each one of the plurality of top grains of the first of the two intermediate layers.

7. The PMR media stack of claim 1, further comprising:
a substrate;
a soft magnetic underlayer on the substrate;
a seed layer on the soft magnetic underlayer, wherein the two intermediate layers are on the seed layer;
a grain isolation initiation layer on the two intermediate layers;
a plurality of magnetic layers on the grain isolation initiation layer;
an exchange breaking layer on each the plurality of magnetic layers;
at least one capping layer on the exchange breaking layer; and
an overcoat layer formed on the at least one capping layer.

8. The PMR media stack of claim 1, wherein:
each of the two intermediate layers comprise at least one of Ru, Co, or Pt; and
the spacer layer comprises at least one of Cu, Al, Ag, or Au.

9. A method of forming a perpendicular magnetic recording (PMR) media stack, the method comprising:
forming two intermediate layers; and
forming a spacer layer between the two intermediate layers, wherein a surface energy of the spacer layer is lower than a surface energy of the two intermediate layers.

10. The method of claim 9, wherein:
the forming the two intermediate layers comprises forming a first of the two intermediate layers by sputtering a first layer at a first pressure and forming a second of the two intermediate layers by sputtering a second layer at a second pressure onto the first layer; and
the first pressure is lower than the second pressure.

11. The method of claim 10, wherein:
the first pressure comprises a range of 2-10 mTorr; and
the second pressure comprises a range of 40-150 mTorr.

12. The method of claim 10, wherein:
the first of the two intermediate layers includes a plurality of grains, each of the plurality of grains being formed with a domed portion such that a valley is formed at a grain boundary between each of the plurality of grains.

13. The method of claim 12, wherein the forming the spacer layer comprises forming the spacer layer in the valley located at the grain boundary between each of the plurality of grains.

14. The method of claim 13, wherein the spacer layer is not formed on the domed portion of the plurality of grains.

15. The method of claim 13, wherein the forming the two intermediate layers further comprises forming a second of the two intermediate layers on the domed portion of each of the plurality of grains of the first of the two intermediate layers.

16. The method of claim 9, further comprising:
forming a substrate;
forming a soft magnetic underlayer on the substrate;
forming a seed layer positioned on the soft magnetic underlayer, wherein the two intermediate layers are formed on the seed layer;
forming a grain isolation initiation layer on the two intermediate layers;
forming a plurality of magnetic layers on the grain isolation initiation layer;
forming an exchange breaking layer on each the plurality of magnetic layers;
forming at least one capping layer on one of the exchange breaking layers; and
forming an overcoat layer on the at least one capping layer.

17. The method of claim 9, wherein:
each of the two intermediate layers comprise at least one of Ru, Co, or Pt; and
the spacer layer comprises at least one of Cu, Al, Ag, or Au.

18. A magnetic hard disk drive, comprising:
a rotatable perpendicular magnetic recording (PMR) media stack; and
a perpendicular magnetic recording write head arranged within the hard disk drive to have an air bearing interface with the PMR media stack when the PMR media stack is rotated, wherein the PMR media stack includes two intermediate layers, and a spacer layer formed between the two intermediate layers, wherein a surface energy of the spacer layer is lower than a surface energy of the two intermediate layers.
